(19) United States
(12) Patent Application Publication
(10) Pub. No.: US 2015/0177014 A1
(43) Pub. Date: Jun. 25, 2015

(54) ROUTE CALCULATION SYSTEM, ROUTE CALCULATION DEVICE, ROUTE CALCULATION METHOD, AND COMPUTER PROGRAM

(71) Applicant: AISIN AW CO., LTD., Anjo-shi, Aichi-ken (JP)

(72) Inventor: Yasuki Hosoi, Anjo (JP)

(73) Assignee: AISIN AW CO., LTD., Anjo-shi, Aichi-ken (JP)

(21) Appl. No.: 14/417,891

(22) PCT Filed: Jul. 23, 2013
(86) PCT No.: PCT/JP2013/069878

§ 371 Date: Jan. 28, 2015

(30) Foreign Application Priority Data
Aug. 29, 2012 (JP) 2012-188251

(51) Int. Cl. G01C 21/34

(52) U.S. Cl. CPC G01C 21/3461

(57) ABSTRACT

In a route calculation process executed for each route calculation condition, an area including a link or an intersection that is target to compute a route calculation cost is determined; an area cost computing condition in which an element giving influence on the route calculation cost is associated with a computing condition for the route calculation cost for the link or the intersection including the element for each route calculation condition and for each area is acquired; and an adequate route from a departure point to a destination is determined for each route calculation condition using the route calculation cost computed based on the determined area and the area cost computing condition associated with the area.

This application is a National Stage of International Application No. PCT/JP2013/069878, filed on Jul. 23, 2013, which claims priority from Japanese Patent Application No. 2012-188251, filed on Aug. 29, 2012, the contents of all of which are incorporated herein by reference in their entirety.

### TECHNICAL FIELD

The present invention relates in general to a route calculation system, a route calculation device, a route calculation method, and a computer program that calculate a route from a departure point to a destination.

### BACKGROUND ART

Recently, many vehicles are mounted with navigation devices that provide travel guidance for vehicle, which enable the driver to easily reach his or her desired destination. The navigation devices here are devices that are capable of detecting a current position of a host vehicle through a GPS receiver or the like, acquiring map data corresponding to the current position through a storage medium such as a DVD-ROM and a HDD or network, and displaying a map on a liquid crystal monitor. In addition, the navigation devices include a route calculation function that calculates an optimum route from the current position of the host vehicle to a destination upon inputting of the desired destination. Then, the navigation devices set the calculated optimum route as a guidance route, display the guidance route on a display screen, and provide voice guidance when having approached an intersection to correctly guide a user to the desired destination. In recent years, some cellular phones, smart phones, PDAs (Personal Digital Assistance), personal computers, and the like have the same function as the aforementioned navigation devices.

In addition, in the aforementioned route calculation function, Dijkstra algorism is generally utilized as the route calculation method to calculate a route from a departure point to a destination. In Dijkstra algorism, a route calculation cost (a link cost and an intersection cost) is computed with respect to each link and each node corresponding to an intersection that are included in the route, and an optimum route is determined based on an added value of the computed route calculation costs. Further, in recent years, it has been proposed to vary computing conditions for the route calculation cost with each area. For example, Japanese Patent Application Publication No. JP-A-2006-292373 describes varying the computing conditions such that link costs for regional roads become smaller than those for national roads in regions where regional roads are maintained better than national roads.

### RELATED ART DOCUMENT

### Patent Document

Patent Document 1: Japanese Patent Application; Publication No. JP-A-2006-292373 (Page 4, FIG. 2)

### SUMMARY OF THE INVENTION

In the technology described in Patent Document 1, it is possible to vary the computing conditions for the route calculation cost in consideration of regional characteristics of the road conditions. However, route calculation conditions were not taken into consideration at all. Here, when a route from a departure point to a destination is calculated, not only one optimum route is calculated, but a route meeting each of a plurality of route calculation conditions is calculated.

The aforementioned route calculation conditions include, for example, “toll road priority” in which traveling on toll roads is prioritized, “general priority” in which traveling on general roads is prioritized, and the like. Each route calculation condition gives priority to different aspects. Therefore, there is a need to vary the computing conditions for the route calculation cost with each route calculation condition. For example, for the “toll road priority,” the computing conditions for the route calculation cost are provided such that the route calculation cost for toll roads becomes smaller compared to other route calculation conditions, by which toll roads are more likely to be selected. When a route is determined for each route calculation condition, it is important to provide the computing conditions for the route calculation cost in consideration of the regional characteristics especially with respect to each route calculation condition. For example, when the computing conditions for the route calculation cost are simply provided such that toll roads are more likely to be selected with the “toll road priority,” an appropriate route may not be calculated in areas where the usage of toll roads are not favorable for users, for example, because of heavy congestion on toll roads.

In order to solve the aforementioned conventional problems, it is an object to provide a route calculation system, a route calculation device, a route calculation method, and a computer program that are capable of, when determining, for each of a plurality of route calculation conditions, a route meeting the route calculation condition, calculating a route further appropriate for users through setting the computing conditions for the route calculation cost for each area in consideration of regional characteristics (road conditions, traffic conditions, resident tendency, and the like) with respect to each route calculation condition.

To achieve the aforementioned object, a route calculation system (1), a route calculation device (1), a route calculation method, and a computer program according to preferred embodiments are a system and a device that determine for each of a plurality of route calculation conditions an adequate route meeting the route calculation condition using the respective unit described below, a route calculation method that determines a route using the system, and a computer program that causes the device to execute the following. Specifically, area determining unit (13) for determining an area including a computing object that is target to compute a route calculation cost; computing condition acquiring unit (13) for acquiring an area cost computing condition in which an element giving influence on the route calculation cost is associated with a computing condition for the route calculation cost for the computing object including the element, for each of the plurality of route calculation conditions and for each area; and route determining unit (13) for determining, for each route calculation condition, the adequate route from the departure point to the destination using the route calculation cost computed based on the area determined by the area determining unit and the area cost computing condition associated with the area, are included.

According to exemplary embodiments of the route calculation system, the route calculation device, the route calculation method, and the computer program having the aforementioned configuration, when determining, for each of a plurality of route calculation conditions, a route meeting the route calculation condition, it is possible to calculate a route matching the route calculation condition and the regional characteristics that is much more appropriate for the user because the computing condition for the route calculation cost is set for each area in consideration of regional characteristics (road conditions, traffic conditions, resident tendency, and the like) with respect to each route calculation condition.

### BRIEF DESCRIPTION OF THE DRAWINGS

FIG. 1 is a block diagram showing a structure of a navigation device according to the present embodiment.

FIG. 2 shows an example of setting criteria for cost coefficient and actual cost coefficients to be set with respect to a route calculation condition “recommended.”

FIG. 3 shows an example of setting criteria for cost coefficient and actual cost coefficients to be set with respect to a route calculation condition “general priority.”

FIG. 4 shows an example of setting criteria for cost coefficient and an actual cost coefficient to be set with respect to a route calculation condition “distance priority.”

FIG. 5 is a flow chart of a route calculation process program according to the present embodiment.

FIG. 6 shows candidates for an adequate route from a departure point intersection to a destination intersection.

FIG. 7 shows an example of an intersection list.

FIG. 8 illustrates a specific example of a determination process of an adequate route based on the intersection list.

FIG. 9 is a flow chart of a sub-process program of a cost computing process.

### DESCRIPTION OF THE PREFERRED EMBODIMENTS

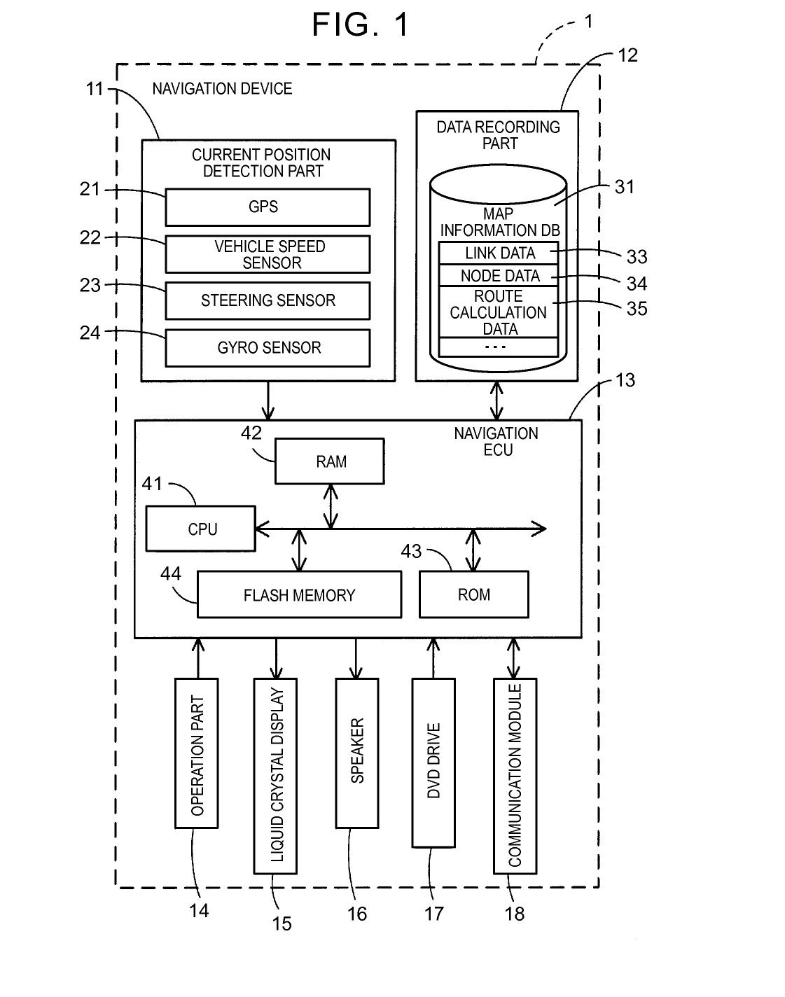

Hereinafter, a specific embodiment of a route calculation system and a route calculation device according to the exemplary embodiment that is implemented in a navigation device will be explained in detail with reference to the drawings. First, a schematic structure of a navigation device 1 according to the present embodiment will be explained with reference to FIG. 1. FIG. 1 is a block diagram showing the navigation device 1 according to the present embodiment.

As shown in FIG. 1, the navigation device 1 according to the present embodiment includes: a current position detection part 11 that detects a current position of a vehicle mounted with the navigation device 1; a data recording part 12 in which various kinds of data is recorded; a navigation ECU 13 that performs various kinds of arithmetic processes based on input information; an operation part 14 that accepts an operation of a user; a liquid crystal display 15 that displays a map image of the vicinity of the vehicle, route information regarding a route calculated by a route calculation process that is described later, and the like, to the user; a speaker 16 that outputs audio guidance regarding route guidance; a DVD drive 17 that reads out a DVD serving as a storage medium; a communication module 18 that performs communication with information centers such as a probe center, a VICS (a registered trademark: Vehicle Information and Communication System) center, and the like.

Hereinafter, the respective components of the navigation device 1 are explained.

The current position detection part 11 includes at least one of a GPS 21, a vehicle speed sensor 22, a steering sensor 23, a gyro sensor 24, and the like, and can detect a current position and a bearing of the vehicle, a traveling speed of the vehicle, a current time, and the like. Here, in particular, the vehicle speed sensor 22 is a sensor for detecting a moving distance and a speed of the vehicle, generates pulses in accordance with a rotation of drive wheels of the vehicle, and outputs pulse signals to the navigation ECU 13. Subsequently, by counting the number of generated pulses, the navigation ECU 13 calculates a rotation speed of the drive wheels and the moving distance. Note that the navigation device 1 is not required to be provided with all the aforementioned four kinds of sensors, and the navigation device 1 may be provided with only one or a plurality of kinds of sensors among them.

The data recording part 12 is provided with a hard disk (not shown) serving as an external storage device and a recording medium, and a recording head (not shown) serving as a driver for reading a map information DB 31, a predetermined program, and the like, which are recorded in the hard disk, and writing predetermined data in the hard disk. The data recording part 12 may be configured by a memory card, or an optical disk such as a CD, a DVD, and the like, in place of the hard disk.

The map information DB 31 is storage unit storing, for example, link data 33 regarding roads (links), node data 34 regarding node points, route calculation data 35 to be utilized for a route calculation process, facility data regarding facilities, map display data for displaying a map, intersection data regarding intersections, point search data for searching for points, and the like.

The link data 33 includes: regarding links forming roads, data indicating widths of roads that the links belong to, inclination, cant, bank, condition of road surface, the number of lanes of roads, positions where the number of lanes decreases, positions where widths are narrowed, rail crossing, and the like; regarding corners, data indicating curvature radii, intersections, T-shaped roads, entrances and exists of corners and the like; regarding road attributes, data indicating down hill lanes, uphill lanes, and the like; and regarding road types, data indicating general roads such as national roads, prefectural roads, narrow streets, and the like, toll roads such as national highways, intercity highways, general toll roads, toll bridges, and the like.

The node data 34 includes data regarding: coordinates (positions) of branch points (including intersections, T-shaped roads, and the like) of actual roads, and node points that are set at each predetermined distance according to curvature radii and the like on roads; node attributes indicating whether nodes correspond to intersections and the like; connected link number lists that are lists of link numbers of links connected to nodes; adjacent node number lists that are lists of node numbers of nodes adjacent to nodes through links; heights (altitudes) of node points, and the like.

The route calculation data 35 includes various kinds of data that is used for a route calculation process to calculate a route from a departure point (for example, a current position of a vehicle) to a set destination, as described below. Specifically, the route calculation data 35 includes cost computing data to be utilized to compute route calculation costs such as costs (hereinafter, referred to as intersection cost) that are obtained by quantifying the degree of appropriateness as a route with respect to intersections, costs (hereinafter, referred to as link cost) that are obtained by quantifying the degree of appropriateness as a route with respect to links forming roads, and the like.

Here, the intersection cost is set to each of the nodes corresponding to the intersections included in the route that is target to compute the route calculation cost. The value of the intersection cost is computed based on the presence or absence of traffic lights, the travel route of the vehicle when passing the intersection (that is, forwarding straight, turning right, or turning left), and the like.

In addition, the link cost is set to each of the links included in the route that is target to compute the calculation cost. The value of the link cost is computed based on the link length in consideration of the road attribute, the road type, the width of the road, the number of lanes of the link, and the like.

Here, the navigation device 1 according to the present embodiment is configured to: determine, for each of a plurality of route calculation conditions, a route (hereinafter, referred to as an adequate route) meeting the route calculation condition; and set, as the guidance route, one route desired by the user from a plurality of adequate routes determined under the respective route calculation conditions. Specifically, the route calculation conditions include four kinds of route calculation conditions of: “recommended” in which the priority is given to the required time to the destination being short as well as easiness of traveling, the expense for traveling, and the like are also considered; “toll road priority” in which the priority is given to traveling on toll roads to the destination; “general priority” in which the priority is given to traveling on general roads to the destination; and “distance priority” in which the priority is given to the travel distance to the destination being short.

In addition, the computing conditions (hereinafter, referred to as cost computing conditions) for the link cost and the intersection cost vary with each route calculation condition and each area. The cost computing conditions for the link cost and the intersection cost are described below. In the following description, the link cost is especially used as an example.

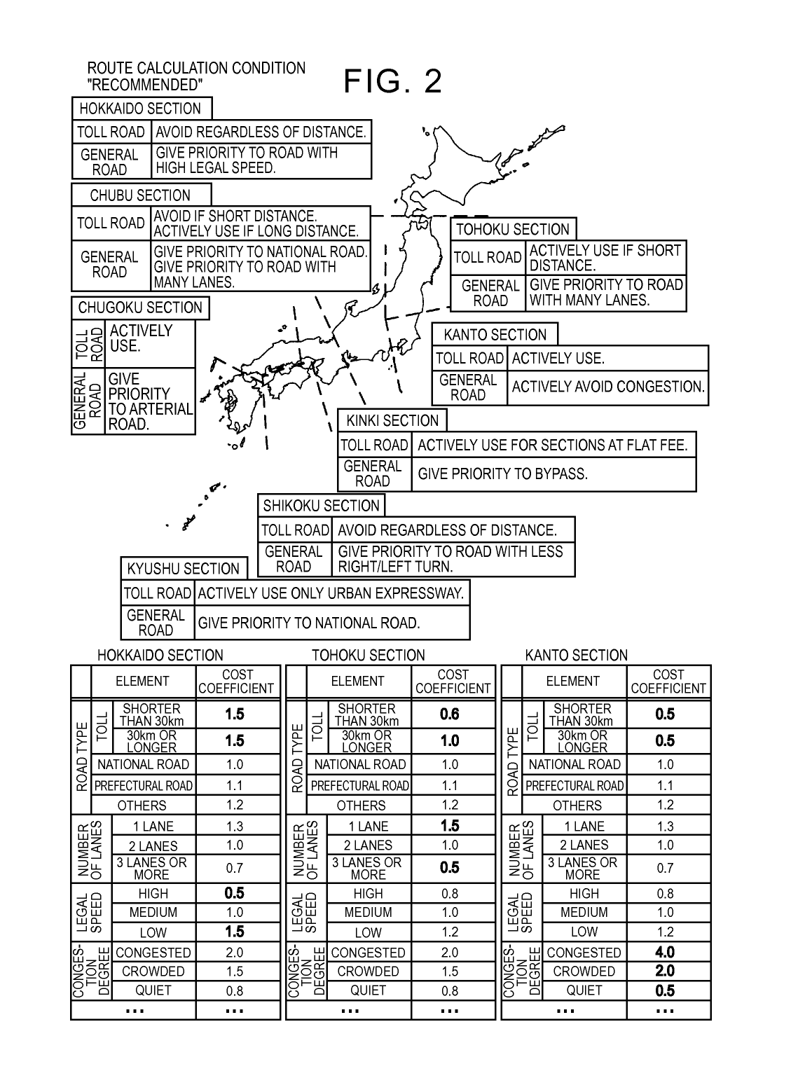

The link cost is computed by multiplying the length of the link that is target to compute the link cost by the coefficient (hereinafter, referred to as cost coefficient) set for each of various elements that give influence on the route calculation cost such as the number of lanes, the road attribute, the congestion degree, and the like, which are included in the link. Consequently, the cost computing condition for the link cost is a condition to define how to set the cost coefficient for each element. The cost coefficients are set with respect to each route calculation condition and each area in consideration of the route calculation conditions and the regional characteristics (more especially, road conditions, traffic conditions, resident tendency, and the like). For example, in case of “recommended,” the cost coefficients are set such that lower costs are assigned to the links that make the travel time shorter in consideration of the elements such as the number of lanes, the road attribute, the congestion degree, and the like that could give influence on the travel time, based on the link length. In addition, the expense for traveling, easiness of traveling, and the like are also taken into consideration. However, there are some areas where it is favorable to give priority to toll roads rather than general roads even when extra expense is caused or where it is favorable not to give priority to the number of lanes. FIG. 2 shows an example of the setting criteria for cost coefficient and actual cost coefficients (area cost computing conditions) to be set with respect to one route calculation condition “recommended”.

As shown in FIG. 2, in the route calculation condition “recommended,” the area (Japan in the present embodiment) included in the map data is sectioned into eight areas according to, so-called, eight regional sectioning. The setting criteria for the cost coefficient are set in consideration of regional characteristics (more specifically, road conditions, traffic conditions, resident tendency, and the like) with respect to each of the eight areas, and the cost coefficients are set based on such criteria.

For example, in Hokkaido section, general roads are relatively quiet and easy to travel on. Thus, the users tend to travel on general roads for preference. Therefore, the cost coefficient for toll roads is set higher than other areas. In addition, in Hokkaido section, many users tend to travel on roads with a high legal speed (for example, equal to or more than 50 km/h) for preference. Therefore, the cost coefficient for roads with a high legal speed is set lower than other areas and the cost coefficient for roads with a low legal speed is set higher than other areas.

In Tohoku section, toll roads are convenient even for short sections. Therefore, the cost coefficient for toll roads (especially, short sections less than 30 km) is set lower than other areas. In addition, in Tohoku section, many users tend to travel on large-size roads with many lanes for preference. Therefore, the cost coefficient for large-size roads with many lanes is set lower than other areas and the cost coefficient for roads with a few lanes is set higher than other areas.

In Kanto section, general roads are heavily congested and difficult to travel on. Thus, the users tend to travel on toll roads for preference. Therefore, the cost coefficient for toll roads is set lower than other areas. In addition, in Kanto section, the scale of congestion is large. Thus, many users travel avoiding congestion. Therefore, the cost coefficient for roads with a low congestion degree is set lower than other areas and the cost coefficient for roads with a high congestion degree is set higher than other areas.

Also, for other areas, the cost coefficients are set based on the setting criteria for the cost coefficient shown in FIG. 2 in the same manner.

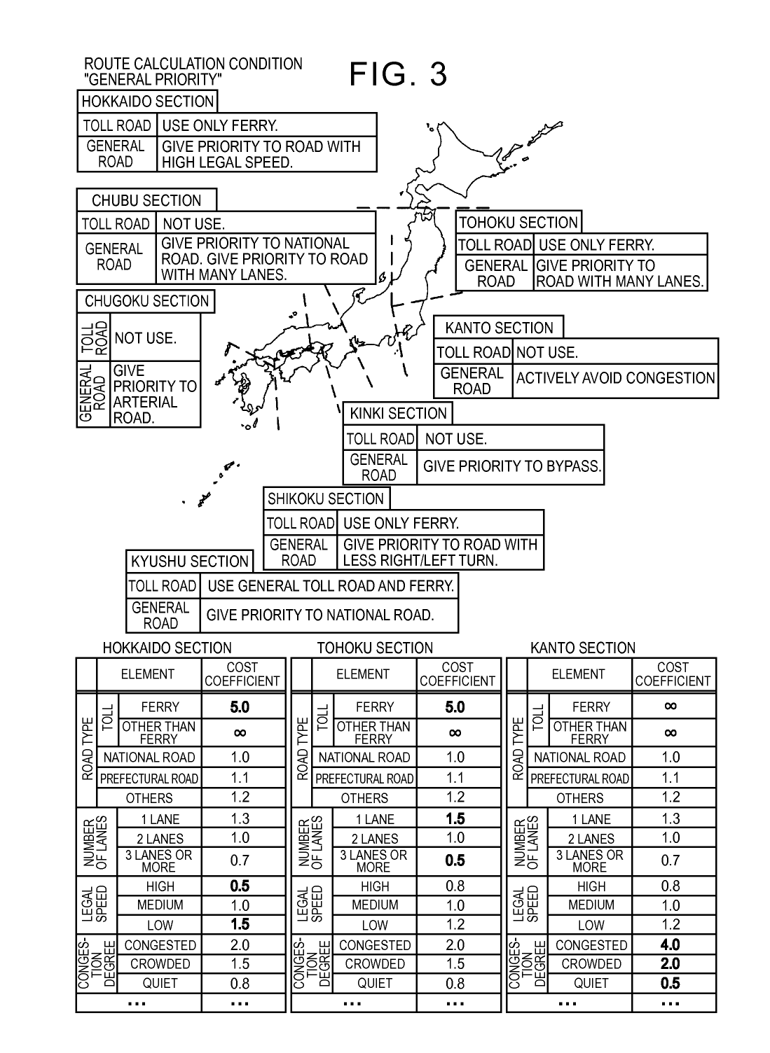

Further, in “general priority,” in addition to the computing method of the aforementioned “recommended,” the cost coefficients are set such that the link costs of links the road types of which are toll road become high. However, there are areas where a route to a destination cannot be calculated if a condition that does not allow any toll roads to be traveled on is provided. FIG. 3 shows an example of setting criteria for cost coefficient and actual cost coefficients (area cost computing conditions) to be set with respect to the route calculation condition “general priority.”

As shown in FIG. 3, in the route calculation condition “general priority,” the area (Japan in the present embodiment) included in the map data is sectioned into eight areas according to, so-called, eight regional sectioning. The setting criteria for cost coefficient are set in consideration of regional characteristics (more specifically, road conditions, traffic conditions, resident tendency, and the like) with respect to each of the eight areas, and the cost coefficients are set based on such criteria.

For example, in Hokkaido section, when the condition provides that toll roads are never traveled on, if a destination is set in an island, Honshu (the main land), or the like, the destination may not be arrived at. Therefore, the cost coefficient is set for a route using a ferry. In addition, in Hokkaido section, many users tend to travel on roads with a high legal speed (for example, equal to or more than 50 km/h) for preference. Therefore, the cost coefficient for roads with a high legal speed is set lower than other areas and the cost coefficient for roads with a low legal speed is set higher than other areas.

In Tohoku section, when the condition provides that toll roads are never traveled on, if a destination is set in Hokkaido or the like, the destination may not be arrived at. Therefore, the cost coefficient is set for a route using a ferry. In addition, in Tohoku section, many users tend to travel on large-size roads with many lanes for preference. Therefore, the cost coefficient for large-size roads with many lanes is set lower than other areas and the cost coefficient for roads with a few lanes is set higher than other areas.

In Kanto section, destinations can be arrived at without using a ferry. Therefore, the cost coefficients are set such that toll roads including ferries are never traveled on. In addition, in Kanto section, the scale of congestion is large. Thus, many users travel avoiding congestion. Therefore, the cost coefficient for roads with a low congestion degree is set lower than other areas and the cost coefficient for roads with a high congestion degree is set higher than other areas.

Also, for other areas, the cost coefficients are set based on the setting criteria for cost coefficient shown in FIG. 3 in the same manner.

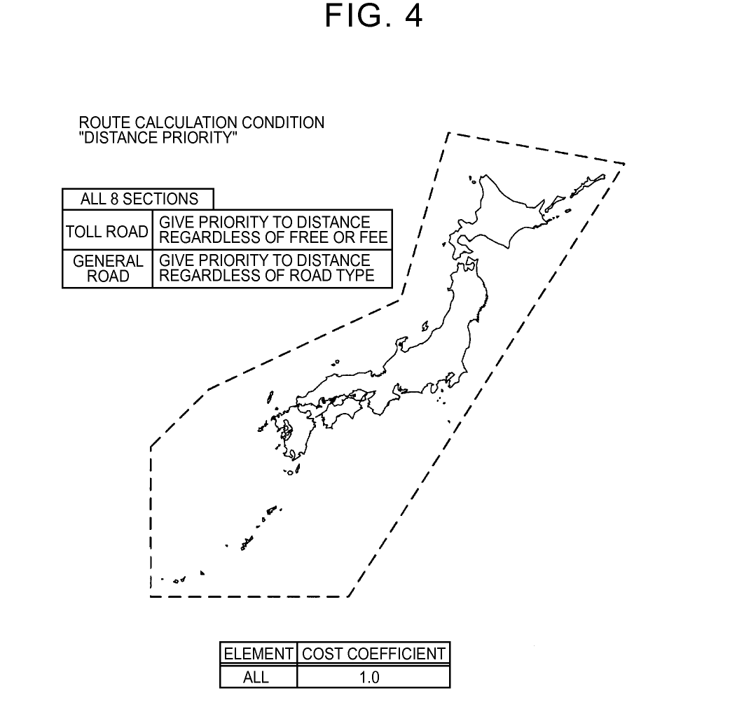

FIG. 4 shows an example of setting criteria for cost coefficient and an actual cost coefficient (an area cost computing condition) to be set with respect to the route calculation condition “distance priority”.

As shown in FIG. 4, in the route calculation condition “distance priority,” the area (Japan in the present embodiment) included in the map data is sectioned into one area. That is, in the “distance priority,” it is necessary to calculate a route with the shortest distance to the destination, regardless of the road type, and free or fee. Therefore, the regional characteristics (specifically, road conditions, traffic conditions, resident tendency, and the like) of each area are not necessary to be considered. Consequently, regarding the cost computing condition, the same condition is provided for the entire area included in the map data. Specifically, the cost coefficient is set to “1” regardless of the elements included in the link and the link cost is computed based on only the link length.

For the route calculation condition “toll road priority,” the setting criteria for cost coefficient are set for each area in consideration of regional characteristics (more specifically, road conditions, traffic conditions, resident tendency, and the like), and the cost coefficients are set based on such criteria.

Then navigation ECU 13 performs route calculation using Dijkstra's algorism based on the route calculation costs such as the link costs, the intersection costs, and the like, which are computed based on the cost coefficients (the area cost computing conditions) set for each route calculation condition and each area. The details of the route calculation process by Dijkstra's algorism are explained later.

In the present embodiment, the area (Japan in the present embodiment) included in the map data is sectioned by the eight regional sectioning. However, the section unit may be the unit of prefecture, the unit of city/village, or the unit of mesh. In addition, the sectioning criteria may be varied with each route calculation condition (for example, the area may be sectioned by the eight regional sectioning for “recommended,” and the area may be sectioned by the unit of prefecture for “general priority.”) In addition, the route calculation data 35 may be stored in the program of a route calculation process program that is described later, instead of being a part of the map data.

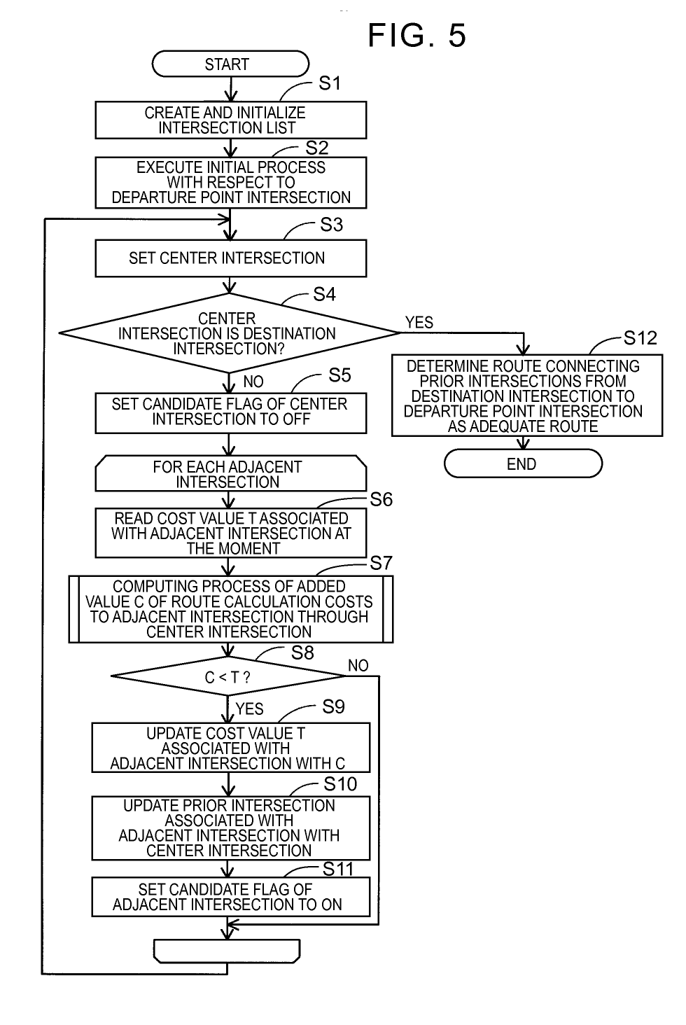

On the other hand, the navigation ECU (electric control unit) 13 is an electronic control unit that performs overall control of the navigation device 1. The navigation ECU 13 is provided with: a CPU 41 serving as a computing device and a control device; internal storage devices such as a RAM 42 used as a working memory when the CPU 41 executes various computing processing and in which route data when the route has been calculated, and the like, are stored, a ROM 43 which records a program for control, and the route calculation process program described later (refer to FIG. 5), and a flash memory 44 which records a program read from the ROM 43; and the like. In addition, the navigation ECU 13 functions as various kinds of unit serving as processing algorithms. For example, area determining unit determines an area including a computing object (a link and/or an intersection) that is target to compute a route calculation cost. Computing condition acquiring unit acquires an area cost computing condition in which an element giving influence on the route calculation cost is associated with a computing condition for the route calculation cost for the computing object including the element, for each of a plurality of route calculation conditions and for each area. Route determining unit determines, for each route calculation condition, an adequate route from the departure point to the destination using the route calculation cost computed based on the area determined by the area determining unit and the area cost computing condition associated with the area.

The operation part 14 is operated for inputting a departure point as a travel starting point and a destination as a travel ending point, and includes various keys and a plurality of operation switches (not shown) such as buttons and the like. The navigation ECU 13 performs control so as to execute the corresponding kinds of operations based on switch signals outputted through pressing the respective switches and the like. The operation part 14 may include a touch panel installed in front of the liquid crystal display 15. The operation part 14 may include a microphone and a voice recognition device.

On the liquid crystal display 15, a map image including roads, traffic information, operation guidance, an operation menu, key guidance, a guidance route from a departure point to a destination, guidance information along the guidance route, news, weather forecast, time, E-mail, TV programs, and the like are displayed.

In addition, when the navigation ECU 13 has performed the route calculation process that is described later, an adequate route determined for each of the plurality of route calculation conditions based on the calculation results are displayed. In addition, when an adequate route includes a toll road such as a highway, a fee required to travel is also displayed. Then, the user selects a route as a guidance route from the displayed plurality of adequate routes.

The speaker 16 outputs audio guidance for traveling along the guidance route based on an instruction from the navigation ECU 13, and the traffic information.

The DVD drive 17 is a drive capable of reading data stored in the recording medium such as a DVD, a CD, and the like. The DVD drive 17 plays music and images, updates the map information DB 31, and the like based on the read data.

The communication module 18 is a communication device for receiving the traffic information including congestion information, regulation information, traffic accident information, and the like, which is transmitted from a traffic information center such as a VICS center, a probe center, and the like. The examples of the communication module 18 are a cellular phone and a DCM.

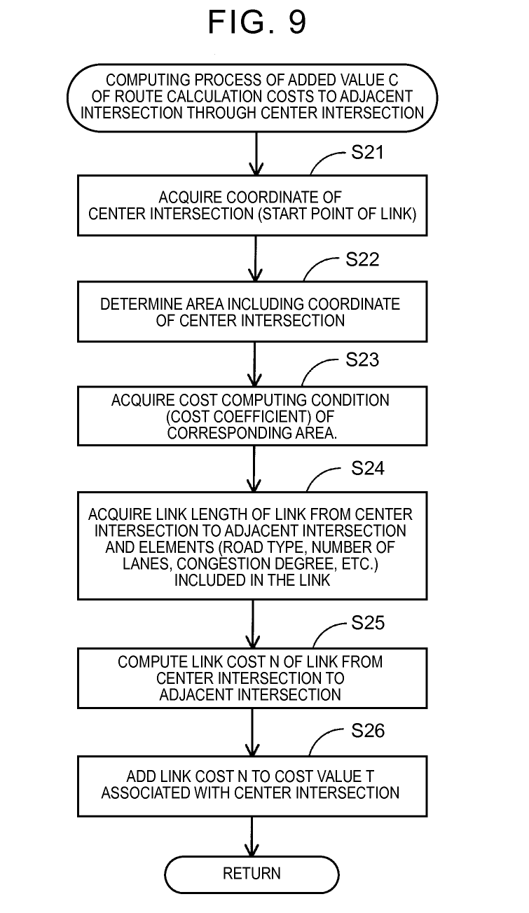

Subsequently, the route calculation process program that is executed by the CPU 41 in the navigation device 1 according to the present embodiment having the aforementioned configurations is explained with reference to FIG. 5. FIG. 5 is a flow chart of the route calculation process program according to the present embodiment. Here, the route calculation process program is executed when a predetermined operation (for example, an operation for setting a destination) to perform a route calculation in the navigation device 1 is accepted, and calculates an adequate route from the departure point to the destination using Dijkstra's algorism. In addition, the route calculation process program is repeatedly executed for each route calculation condition and an adequate route is determined for each route calculation condition. That is, in the present embodiment, the route calculation is performed under four kinds of route calculation conditions of “recommended,” “toll road priority,” “general priority,” and “distance priority.” Thus, the route calculation process program is executed 4 times. In addition, in the description of the embodiment below, for simple explanation, only the link cost is considered as the route calculation cost, and the intersection cost or other costs are not considered. The programs shown by the flow charts in FIGS. 5 and 9 are stored in the RAM 42 or in the ROM 43 provided in the navigation device 1, and executed by the CPU 41.

Initially, in the route calculation process program, at Step (hereinafter, referred to as S) 1, the CPU 41 creates an intersection list based on a departure point intersection, a destination intersection, and the map information stored in the map information DB 31, and stores the created intersection list in a storage medium such as the RAM 42. In addition, the CPU 41 also initializes the created intersection list. Note that the departure point intersection is an intersection (for example, an intersection located closest to the departure point) corresponding to a departure point (for example, the current position of the vehicle) and the destination intersection is an intersection (for example, an intersection located closest to the destination) corresponding to the set destination.

Here, the intersection list is a list of intersections (including the departure point intersection and the destination intersection) connecting adequate route candidates from the departure point intersection and the destination intersection. In addition, in the intersection list, each of the listed intersections is associated with a cost value T indicating the smallest added value of the route calculation costs from the departure point intersection to the subject intersection, a prior intersection that is an intersection to be passed just before the subject intersection to achieve the cost value T, and a candidate flag indicating a candidate for setting a center intersection.

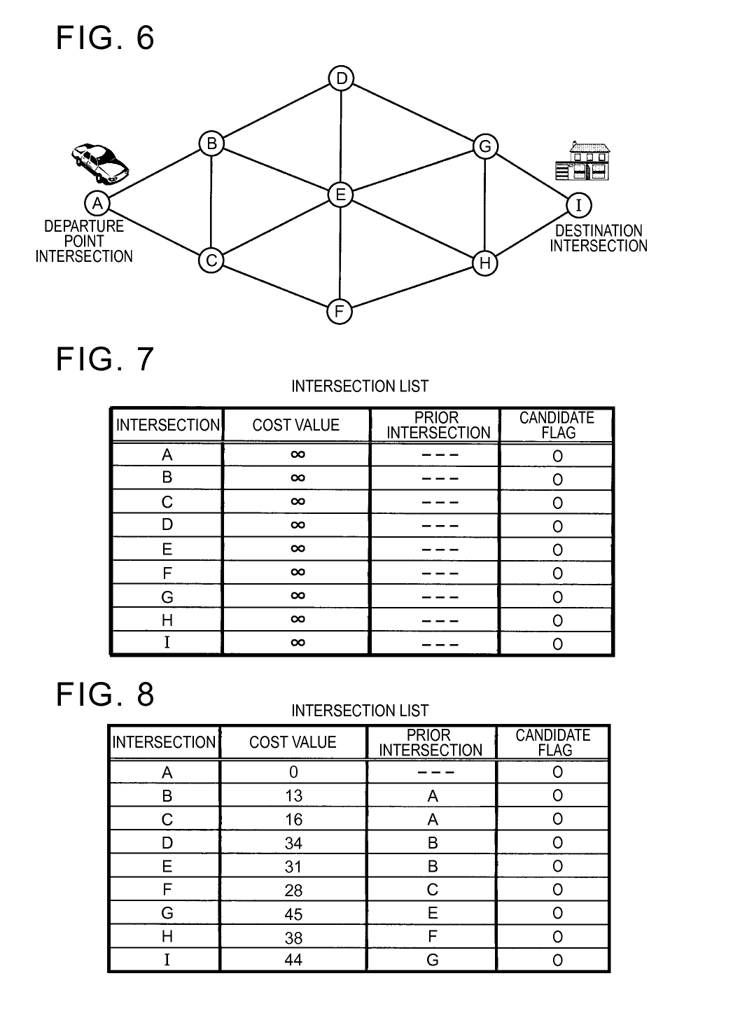

In the following explanation, a case is explained as an example, in which the route calculation process from the departure point intersection A to the destination intersection I shown in FIG. 6 is executed. When the route calculation process from the departure point intersection A to the destination intersection I shown in FIG. 6 is executed, an intersection list is created, in which nine intersections A to I connecting the links which may form the adequate route from the departure point intersection A to the destination intersection I are listed (refer to FIG. 7).

In addition, in the initialization process of the intersection list to be executed at S1, the cost values T associated with all the listed intersections are set to infinity, the prior intersections are not associated, and the candidate flags are set to “OFF (0),” as shown in FIG. 7.

Next, at S2, the CPU 41 executes the initialization process with respect to the departure intersection. Specifically, the CPU 41 sets the cost value T associated with the departure point intersection A of the intersection list to 0, and sets the candidate flag to “ON (1).”

Subsequently, at S3, the CPU 41 sets a center intersection. Specifically, the intersection associated with the smallest cost value T among the intersections the candidate flags of which are set to “ON (1)” is set as the center intersection. Note that, when the process at S3 is executed for the first time after starting the route calculation process program, the candidate flag has been set to “ON (1)” only for the departure point intersection. Therefore, the departure point intersection is inevitably set as the center intersection. On the other hand, when the process at S3 is executed for the second or subsequent time, the intersection associated with the smallest cost value T among the adjacent intersections (a past adjacent intersection may be included when the associated candidate flag is “ON (1)”) that are adjacent to the intersection set as the center intersection at the moment, is newly set as the center intersection.

Thereafter, at S4, the CPU 41 determines whether the intersection newly set as the center intersection at S3 is the destination intersection.

When it has been determined that the intersection newly set as the center intersection at S3 is the destination intersection (S4: YES), the procedure proceeds to S12. On the other hand, when it has been determined that the intersection newly set as the center intersection at S3 is not the destination intersection (S4: NO), the procedure proceeds to S5.

At S5, the CPU 41 sets the candidate flag that is associated with the intersection newly set as the center intersection at S3 to “OFF (0).”

The processes of the subsequent S6 to S11 are repeatedly executed for each intersection (hereinafter, referred to as adjacent intersection) that is adjacent to the intersection newly set as the center intersection at S3 among the intersections listed in the intersection list.

First, at S6, the CPU 41 reads out the cost value T associated with an adjacent intersection in the intersection list at the moment.

Next, at S7, the CPU 41 executes a cost computing process (FIG. 9) that is described later. The cost computing process is a process of computing the added value C of the route calculation costs of the route from the departure point intersection to the adjacent intersection through the center intersection based on the cost computing conditions (FIG. 2 to FIG. 4) set for each route calculation condition and each area. Specifically, the added value C is a value acquired by adding the route calculation cost from the center intersection to the adjacent intersection to the cost value T associated with the center intersection.

Thereafter, at S8, the CPU 41 determines whether the added value C of the route calculation costs of the route from the departure point intersection to the adjacent intersection through the center intersection computed at S7 is smaller than the cost value T associated with the adjacent intersection at the moment.

When it has been determined that the added value C of the route calculation costs of the route from the departure point intersection to the adjacent intersection through the center intersection computed at S7 is smaller than the cost value T associated with the adjacent intersection at the moment (S8: YES), it is predicted that the appropriate route to the adjacent intersection is the route through the current center intersection. Thereafter, the procedure proceeds to S9. On the other hand, when it has been determined that the added value C of the route calculation costs of the route from the departure point intersection to the adjacent intersection through the center intersection computed at S7 is equal to or greater than the cost value T associated with the adjacent intersection at the moment (S8: NO), it is predicted that the appropriate route to the adjacent intersection is not the route through the current center intersection. Then, the procedure proceeds to the process with respect to another adjacent intersection without the cost value T and the like associated with the adjacent intersection being updated.

At S9, the CPU 41 updates the cost value T associated with the adjacent intersection at the moment with the added value C computed at S7.

At S10, the CPU 41 updates the prior intersection associated with the adjacent intersection with the current center intersection.

In addition, at S11, the CPU 41 sets the candidate flag associated with the adjacent intersection to “ON (1).” That is, the adjacent intersection becomes a candidate for a new center intersection.

After the processes S6 to S11 have been executed with respect to all of the adjacent intersection(s) adjacent to the center intersection among the intersections listed in the intersection list, the procedure returns to S3.

At S12 that is executed when it has been determined in the determination process at S4 that the intersection newly set as the center intersection at S3 is the destination intersection, the CPU 41 determines, as the adequate route, the route connecting the prior intersections from the destination intersection to the departure point intersection based on the finalized intersection list. As a result, the route with the smallest added value of the route calculation costs from the departure point intersection to the destination intersection is determined as the adequate route. For example, when the intersection list shown in FIG. 8 is finally acquired, the route connecting the intersection A→the intersection B→the intersection E→the intersection G→the intersection I is determined.

The adequate route determined at S12 is provided for each route calculation condition to the user through the liquid crystal display 15 or the like. Thereafter, one adequate route selected based on an operation of the user is set as the guidance route of the navigation device 1, and travel guidance is provided based on the set guidance route.

Next, the sub-process of the cost computing process executed at S7 is explained with reference to FIG. 9. FIG. 9 is a flow chart of a sub-process program of the cost computing process.

Initially, at S21, the CPU 41 acquires the coordinate of the center intersection based on the map data stored in the map information DB 31. Note that the coordinate of the center intersection is the start point (a point where a vehicle or the like that has left a departure point starts a travel of the link) of the link from the center intersection to the adjacent intersection.

Next, at S22, the CPU 41 determines the area including the coordinate of the center intersection based on the coordinate of the center intersection acquired at S21. Specifically, the CPU 41 determines the area based on the coordinate of the center intersection and a background polygon of a map image sectioned by area. Note that the area to be determined depends on the setting section for cost computing conditions. For example, when the cost computing conditions are set for each of the eight regional sections as shown in FIGS. 2 and 3, the area is determined based on the areas (for example, Hokkaido section, Kanto section, and the like) sectioned by the eight regional sectioning. In addition, the area determined at S22 corresponds to the area including the link from the center intersection to the adjacent intersection. However, when the link straddles a plurality of areas, the area including the start point of the link is determined.

Subsequently, at S23, the CPU 41 acquires the cost computing condition(s) of the area determined at S22. As described above, the same cost computing condition(s) are provided for the area sectioned into the same section. In addition, the cost computing condition especially for the link cost is a condition to define how to set the cost coefficient for each element such as the number of lanes, the road type, the congestion degree (refer to FIGS. 2 to 4).

Thereafter, at S24, the CPU 41 acquires the link length of the link from the center intersection to the adjacent intersection and the elements (the number of lanes, the road type, the congestion degree, and the like) included in the link, based on the link data 33 stored in the map information DB 31, the traffic information (for example, VICS information) received from an external center, and the like.

Next, at S25, the CPU 41 computes a link cost N of the link from the center intersection to the adjacent intersection based on the link length of the link from the center intersection to the adjacent intersection and the elements included in the link that were acquired at S24. Specifically, the link cost N is computed by multiplying the link length of the link by the cost coefficient set to each of the elements included in the link. For example, when a route calculation is performed under the route calculation condition “recommended,” if the center intersection is located in Kanto section and the link from the center intersection to the adjacent intersection has the link length of “20,” belongs to national road with 3 lanes, has the legal speed of 60 km/h, and has the congestion degree as “quiet;” the link cost N of the link from the center intersection to the adjacent intersection is computed according to the following formula (1).

N=20 (link length)×1.0 (national road)×0.7 (3 lanes)×0.8 (legal speed “fast”)×0.5 (congestion degree “quiet”)=5.6 (1)

Subsequently, at S26, the CPU 41 adds the link cost N computed at S25 to the cost value T associated with the center intersection. The resultant value becomes the added value C of the route calculation costs of the route from the departure point intersection to the adjacent intersection through the center intersection. Thereafter, the procedure proceeds to the determination process at S8.

As described in detail above, in the navigation device 1 according to the present embodiment, the route calculation method according to the navigation device 1, and the computer program executed at the navigation devicel, in the route calculation process executed for each route calculation condition, the area including the link or the intersection that is target to calculate the route calculation cost is determined (S22); the area cost computing condition in which an element giving influence on the route calculation cost is associated with a computing condition for the route calculation cost for the link or the intersection including the element for each route calculation condition and each area is acquired (S23); and an adequate route from the departure point to the destination is determined for each route calculation condition using the route calculation costs computed based on the determined area and the area cost computing condition(s) associated with the area (S1 to S12). Therefore, when determining a route meeting each of a plurality of route calculation conditions, it is possible to calculate a route matching the route calculation condition and the regional characteristics that is much more appropriate for the user because the computing condition(s) for the route calculation cost are set for each area in consideration of regional characteristics (road conditions, traffic conditions, resident tendency, and the like) with respect to each route calculation condition.

In addition, the cost coefficient(s) to be used when computing a link cost are set for each area in consideration of regional characteristics (road conditions, traffic conditions, resident tendency, and the like) with respect to each route calculation condition. Therefore, it is possible to compute an appropriate link cost based on the elements of the road type, the number of lanes, the congestion degree, and the like included in the link.

In addition, when the link that is target to compute the route calculation cost straddles a plurality of areas, the area including the start point of the link is determined as the area including the link. Therefore, it is possible to appropriately determine the area that has the greatest influence on the link that is target to compute the route calculation cost.

In addition, the area including the link or the intersection that is target to compute the route calculation cost is determined based on the coordinate determining the position of the link or the intersection that is target to compute the route calculation cost and the background polygon of the map image sectioned by area. Therefore, it is possible to accurately determine the area including the link or the intersection based on the map image and the coordinate point without performing complicated processes.

In addition, the area included in the map data is sectioned under different criteria for each of the plurality of route calculation conditions, and the same computing condition(s) for the route calculation cost are provided for the area sectioned into the same section. Therefore, it is possible to section the area under appropriate criteria with respect to each route calculation condition such that the same computing condition(s) for the route calculation cost are appropriately set. Consequently, it is possible to compute an appropriate route calculation cost in consideration of regional characteristics.

In addition, with respect to the route calculation condition “distance priority” which gives priority to that the travel distance from the departure point to the destination is short, the same computing condition for the route calculation cost is provided for the entire area included in the map data. Therefore, it is possible to determine an adequate route only in consideration of the travel distance from the departure point to the destination while the regional characteristics are taken into consideration for other route calculation conditions.

Those skilled in the art will understand that various kinds of improvements or variations can be made without departing from the broad spirit and scope of the underlying principles.

For example, in the present embodiment, an adequate route is determined for each of four kinds of route calculation conditions. However, an adequate route may be determined for each of two, three, or five kinds of route calculation conditions. In such case, the area cost computing conditions need to be created in accordance with the number of the route calculation conditions.

In addition, in the present embodiment, the cost computing conditions especially for the link cost are explained as an example with reference to FIGS. 2 to 4. However, the cost computing conditions may be set also for the intersection cost for each route calculation condition and each area in the same manner as the link cost. For example, the cost computing conditions are set such that, for Kanto section and Kinki section where there are many traffic lights, the intersection cost for the intersections with traffic lights is set lower than other areas, and, for Kanto section and Kinki section where the traffic is heavy, the intersection cost for intersections for right turn is set higher than other areas. The CPU 41 determines the area including the intersection that is target to compute the cost and computes the intersection cost for the intersection using the cost computing condition(s) of the determined area.

In addition, as for the cost computing conditions for the intersection cost, the same conditions may be applied regardless of route calculation conditions (that is, conditions varying only with each area). Also, only the cost computing conditions for either the link cost or the intersection cost may be varied by area.

In addition, the cost computing condition(s) may be set based on the area where the user lives instead of the area where the link or the node is located. Or, both the computing condition(s) for the cost based on the area where the link or the node is located and the computing condition(s) for the cost based on the area where the user lives may be applied. In such case, the regional characteristics based on the road condition and the regional characteristics based on the character of the residents may be considered. For example, when a resident of Hokkai section travels to Kanto, the cost coefficients of Kanto section are adapted for the congestion degree (factor by the road condition) and the cost coefficients of Hokkaido section are adapted for toll roads (the mind of the residents that are not familiar with toll roads).

In the present embodiment, the added value C of the route calculation costs is computed in consideration of only the link cost that is necessary to travel the link. However, the added value C of the route calculation costs may be computed in consideration of the intersection cost that is necessary to pass the intersection or other costs.

In the present embodiment, when the link that is target to compute the route calculation cost straddles a plurality of areas, the area including the start point of the link is determined as the area including the link. However, the area including the end point of the link may be determined as the area including the link. In addition, based on the rate of the length in which the link is included in each area, the area with high rate may be determined as the area including the link.

The present embodiment may be applied to, in addition to the navigation devices, devices having a route calculation function. For example, the present embodiment may be applied to portable terminals such as cellular phones, smart phones, and the like, personal computers, and the like (hereinafter, referred to as portable terminals and the like). In addition, the present embodiment may be applied to systems including servers and portable terminals and the like. In such case, the respective steps of the above-mentioned route calculation process program (FIGS. 5 and 9) may be executed either the servers or the portable terminals and the like. In addition, when the present embodiment is applied to the portable terminals and the like, the present embodiment may be applied to the route calculation for movable bodies other than vehicles, for example, users of portable terminals and the like, two wheels, and the like.

A specific embodiment of the route calculation system is described above. However, the route calculation system may have the configurations as follows.

For example, a first configuration is as follows.

The computing object is a link or a node corresponding to an intersection.

According to the route calculation system having the aforementioned configuration, it is possible to set the computing condition for a link cost and an intersection cost for each area in consideration of regional characteristics (road conditions, traffic conditions, resident tendency, and the like) with respect to each route calculation condition.

In addition, a second configuration is as follows.

The computing object is a link; the route calculation cost for the link is computed by multiplying a link length of the link by a coefficient based on an element included in the link; and the computing condition for the route calculation cost provides a value of the coefficient for each element.

According to the route calculation system having the aforementioned configuration, the coefficient to be used when computing a link cost is set for each area in consideration of regional characteristics (road conditions, traffic conditions, resident tendency, and the like) with respect to each route calculation condition. Therefore, it is possible to compute an appropriate link cost based on the element such as a road type, the number of lanes, a congestion degree, and the like included in the link.

In addition, a third configuration is as follows.

The computing object is a link; the area determining unit, when a link that is target to compute the route calculation cost straddles a plurality of areas, determines an area including a start point of the link as an area including the link.

The “start point of the link” is a point at which a vehicle or the like that has left a departure point starts a travel of the link.

According to the route calculation system having the aforementioned configuration, when the link that is target to compute the route calculation cost straddles a plurality of areas, the area including the start point of the link is determined as the area including the link. Therefore, it is possible to appropriately determine the area that has the greatest influence on the link that is target to compute the route calculation cost.

In addition, a fourth configuration is as follows.

The area determining unit determines an area including the computing object that is target to compute the route calculation cost based on a coordinate determining a position of the computing object that is target to compute the route calculation cost and a background polygon of a map image sectioned by area.

According to the route calculation system having the aforementioned configuration, the area including the computing object that is target to compute the route calculation cost is determined based on the coordinate determining the position of the computing object that is target to compute the route calculation cost and the background polygon of the map image sectioned by area. Therefore, it is possible to accurately determine the area including the computing object based on the map image and the coordinate point without performing complicated processes.

In addition, a fifth configuration is as follows.

The area cost computing condition provide a same computing condition for the route calculation cost with respect to an area in a same section, the section being set by sectioning the area included in map data under different criteria for each of the plurality of route calculation conditions.

According to the route calculation system having the aforementioned configuration, the area included in the map data is sectioned under different criteria for each of the plurality of route calculation conditions, and the same computing condition for the route calculation cost is provided for the area in the same section. Therefore, it is possible to section the area under appropriate criteria with respect to each route calculation condition such that the same computing condition for the route calculation cost is appropriately set. Consequently, it is possible to compute an appropriate route calculation cost in consideration of regional characteristics.

In addition, a sixth configuration is as follows.

The plurality of route calculation conditions include a route calculation condition with distance priority which gives priority to that a travel distance from the departure point to the destination is short, and the area cost computing condition associated with the distance priority provide a same computing condition for the route calculation cost for an entire area included in the map data.

According to the route calculation system having the aforementioned configuration, with respect to the route calculation condition with distance priority which gives priority to that a travel distance from the departure point to the destination is short, the same computing condition for the route calculation cost is provided for the entire area included in the map data. It is possible to determine an adequate route only in consideration of the travel distance from the departure point to the destination while the regional characteristics are taken into consideration for other route calculation conditions.

### DESCRIPTION OF THE REFERENCE NUMERALS

1: NAVIGATION DEVICE
13: NAVIGATION ECU
41: CPU
42: RAM
43: ROM

1. A route calculation system that determines, for each of a plurality of route calculation conditions, an adequate route meeting the route calculation condition as a route from a departure point to a destination, the route calculation system comprising:
area determining module for determining an area including a computing object that is target to compute a route calculation cost;
computing condition acquiring module for acquiring an area cost computing condition in which an element giving influence on the route calculation cost is associated with a computing condition for the route calculation cost for the computing object including the element, for each of the plurality of route calculation conditions and for each area; and
route determining module for determining, for each route calculation condition, the adequate route from the departure point to the destination using the route calculation cost computed based on the area determined by the area determining means and the area cost computing condition associated with the area.

2. The route calculation system according to claim 1, wherein the computing object is a link or a node corresponding to an intersection.

3. The route calculation system according to claim 1, wherein the computing object is a link;
the route calculation cost for the link is computed by multiplying a link length of the link by a coefficient based on an element included in the link; and
the computing condition for the route calculation cost provides a value of the coefficient for each element.

4. The route calculation system according to claim 1, wherein the computing object is a link;
the area determining module, when a link that is target to compute the route calculation cost straddles a plurality of areas, determines an area including a start point of the link as an area including the link.

5. The route calculation system according to claim 1, wherein the area determining module determines an area including the computing object that is target to compute the route calculation cost based on a coordinate determining a position of the computing object that is target to compute the route calculation cost and a background polygon of a map image sectioned by area.

6. The route calculation system according to claim 1, wherein the area cost computing condition provides a same computing condition for the route calculation cost with respect to an area in a same section, the section being set by sectioning the area included in map data under different criteria for each of the plurality of route calculation conditions.

7. The route calculation system according to claim 6, wherein the plurality of route calculation conditions include a route calculation condition with distance priority which gives priority to that a travel distance from the departure point to the destination is short, and
the area cost computing condition associated with the distance priority provides a same computing condition for the route calculation cost for an entire area included in the map data.

8. A route calculation device that determines, for each of a plurality of route calculation conditions, an adequate route meeting the route calculation condition as a route from a departure point to a destination, the route calculation device comprising:
area determining module for determining an area including a computing object that is target to compute a route calculation cost;
computing condition acquiring module for acquiring an area cost computing condition in which an element giving influence on the route calculation cost is associated with a computing condition for the route calculation cost for the computing object including the element, for each of the plurality of route calculation conditions and for each area; and
route determining module for determining, for each route calculation condition, the adequate route from the departure point to the destination using the route calculation cost computed based on the area determined by the area determining module and the area cost computing condition associated with the area.

9. A route calculation method that determines, for each of a plurality of route calculation conditions, an adequate route meeting the route calculation condition as a route from a departure point to a destination, the route calculation method comprising:
area determining step of determining an area including a computing object that is target to compute a route calculation cost;
computing condition acquiring step of acquiring an area cost computing condition in which an element giving influence on the route calculation cost is associated with a computing condition for the route calculation cost for the computing object including the element, for each of the plurality of route calculation conditions and for each area; and
route determining step of determining, for each route calculation condition, the adequate route from the departure point to the destination using the route calculation cost computed based on the area determined at the area determining step and the area cost computing condition associated with the area.

10. A computer program contained on a non-transitory readable medium that causes a computer to determine, for each of a plurality of route calculation conditions, an adequate route meeting the route calculation condition as a route from a departure point to a destination, the computer program operable for causing the computer to execute:
area determining function of determining an area including a computing object that is target to compute a route calculation cost;
computing condition acquiring function of acquiring an area cost computing condition in which an element giving influence on the route calculation cost is associated with a computing condition for the route calculation cost for the computing object including the element, for each of the plurality of route calculation conditions and for each area; and
route determining function of determining, for each route calculation condition, the adequate route from the departure point to the destination using the route calculation cost computed based on the area determined by the area determining function and the area cost computing condition associated with the area.
